(19) United States
(12) Patent Application Publication
(10) Pub. No.: US 2018/0237309 A1
(43) Pub. Date: Aug. 23, 2018

(54) METHOD FOR PREPARING TRANSPARENT YTTRIA THROUGH HOT-PRESS SINTERING

(71) Applicant: KOREA INSTITUTE OF MACHINERY & MATERIALS, Daejeon (KR)

(72) Inventors: Young Jo PARK, Changwon-si (KR); Ha Neul KIM, Pohang-si (KR); Jin Myung KIM, Changwon-si (KR); Jae Woong KO, Changwon-si (KR); Jae Wook LEE, Seoul (KR)

(21) Appl. No.: 15/752,630

(22) PCT Filed: Apr. 22, 2016
(86) PCT No.: PCT/KR2016/004240

§ 371 Date: Feb. 14, 2018

(30) Foreign Application Priority Data
Aug. 25, 2015 (KR) 10-2015-0119799

(51) Int. Cl. C01F 17/00; B22F 3/15; B30B 15/00

(52) U.S. Cl. CPC C01F 17/0043; B22F 3/15; B30B 15/0029; C01P 2006/90; B22F 2301/45; B22F 2302/25; B22F 2999/00; B22F 2003/153

(57) ABSTRACT

The present invention relates to a method of manufacturing a light transmitting yttria member by using hot-press sintering. The present invention provides a method of manufacturing light transmitting yttria by performing hot-press sintering on a molded body made of raw material powder including yttria by using a hot-press sintering apparatus, in which the hot-press sintering is performed in a state in which a spacer is interposed between the molded body and a pressing surface of the molded body, and the spacer is made of heat-resistant metal which is substantially unreactive to the molded body at a sintering temperature. According to the present invention, it is possible to manufacture highly compacted light transmitting yttria having light transmittance of 80% by using a single hot-press sintering process.

### TECHNICAL FIELD

The present invention relates to a method of manufacturing light transmitting yttria, and more particularly, to a method of manufacturing a light transmitting yttria member using hot-press sintering.

### BACKGROUND ART

Yttria is excellent in terms of light transmission, plasma resistance, corrosion resistance, and the like, such that yttria is widely used for a semiconductor manufacturing apparatus or an optical member.

The most general method of sintering polycrystalline yttria transparently is to perform three processes including ‘vacuum sintering+annealing in the air+HIP’. In this case, an expensive apparatus, which includes a tungsten heating element and a tungsten/molybdenum thermal insulator to prevent carbon contamination, is used as a preferred vacuum sintering apparatus. Meanwhile, oxygen vacancy, which occurs in a sintered body during the vacuum sintering, is a factor that causes deterioration in transmittance due to absorption, and as a result, it is necessary to necessarily perform a vacancy filling process using annealing in the air.

In this method, HIP processing is required in the last step in order to perform net density sintering for completely removing pores, and as a result, it is difficult to prevent a restriction to productivity and an increase in costs of products.

Hot-press sintering (hot press) is a method of manufacturing a sintered body by applying uniaxial pressure in a vacuum ambience at a high temperature, and this method is well known as a useful method of obtaining a compacted sintered body. However, transparency deteriorates due to formation of oxygen vacancy in the sintered body and carbon contamination in the case in which only the hot-press sintering is performed, such that a subsequent process is required, and as a result, it is known that this method is not suitable for manufacturing light transmitting yttria.

### DISCLOSURE

### Technical Problem

The present invention has been made in an effort to solve the aforementioned problems in the related art, and an object of the present invention is to provide a method of manufacturing an yttria sintered body with high transparency by using hot-press sintering.

In addition, another object of the present invention is to provide a method of manufacturing an yttria sintered body with high transparency by using hot-press sintering without adding an annealing process.

In addition, still another object of the present invention is to provide a method of manufacturing light transmitting yttria having low oxygen vacancy concentration by using hot-press sintering.

In addition, yet another object of the present invention is to provide a light transmitting yttria sintered component manufactured by the aforementioned method.

In addition, still yet another object of the present invention is to provide a method of manufacturing light transmitting yttria by removing a defect of the aforementioned light transmitting yttria sintered component.

### Technical Solution

To solve the aforementioned technical problems, the present invention provides a method of manufacturing light transmitting yttria by performing hot-press sintering on a molded body made of raw material powder including yttria by using a hot-press sintering apparatus, in which the hot-press sintering is performed in a state in which a spacer is interposed between the molded body and a pressing surface of the molded body, and the spacer is made of heat-resistant metal which is substantially unreactive to the molded body at a sintering temperature.

In the present invention, the heat-resistant metal may include at least one type of metal selected from a group consisting of Ta, Mo, W, and Pt.

In addition, in the present invention, the sintering temperature may be selected within a range from 1,500 to 1,700° C.

In the present invention, the spacer may have a plate shape or a foil shape. In addition, the spacer may be formed to surround an outer circumference of the molded body.

The spacer may be separated from the light transmitting yttria after the sintering.

In the present invention, the sintering may be performed in a vacuum ambience, and the hot-press sintering apparatus may include a graphite heater.

In addition, in the present invention, the raw material powder may further include a sintering additive, and the sintering additive may be a tetravalent metal compound.

According to another aspect of the present invention for solving the aforementioned technical problems, the present invention provides a method of manufacturing light transmitting yttria from a molded body made of raw material powder including yttria, the method including: presintering the molded body; and sintering the molded body by hot-press sintering by interposing a spacer between the molded body and a pressing surface of the molded body, in which the spacer surrounds an outer circumference of the molded body and is made of heat-resistant metal which is substantially unreactive to the molded body at a sintering temperature.

In this case, the method may further include performing an HIP process after the hot-press sintering. In addition, in this case, a presintering temperature may be 1,250 to 1,450° C., a hot-press sintering temperature may be 1,500 to 1,700° C., and more particularly, the presintering temperature may be 1,400° C. or higher.

To solve the aforementioned technical problems, the present invention provides a light transmitting yttria sintered component which includes a tetravalent metal element of 0.1 to 5 at % as a sintering additive, in which specific electrical resistance is 1.0 to 5.0×10⁹ Ωcm.

To solve the aforementioned technical problems, the present invention provides a light transmitting yttria sintered component which includes a tetravalent metal element of 0.1 to 5 at % as a sintering additive, the light transmitting yttria sintered component including: a light transmitting yttria body which has specific electrical resistance of 1.0 to 5.0×10⁹ Ωcm; and an unreactive heat-resistant metal spacer which surrounds the light transmitting yttria body. In this case, the heat-resistant metal spacer may have a foil shape.

### Advantageous Effects

According to the present invention, it is possible to manufacture highly compacted light transmitting yttria having transmittance of 80% in respect to visible light and infrared rays by using a single hot-press sintering process.

### DESCRIPTION OF DRAWINGS

FIG. 1 is a view schematically illustrating an example of press-molding an yttria molded body according to an exemplary embodiment of the present invention.

FIG. 2 is a view schematically illustrating a procedure of a process of manufacturing the light transmitting yttria according to the exemplary embodiment of the present invention.

FIGS. 3A and 3B are electron micrographs obtained by capturing images of microstructures of a specimen to which vacuum sintering, annealing, and HIP processes are applied and a specimen to which hot-press sintering is applied.

FIG. 4 is a graph obtained by measuring in-line transmittance of a specimen manufactured according to the exemplary embodiment of the present invention.

FIG. 5 is a graph illustrating IR transmittance aspects before and after annealing a vacuum sintered specimen.

FIG. 6 is a graph illustrating Raman analysis results in respect to specimens manufactured by various sintering processes.

FIG. 7 is a procedure diagram schematically illustrating a procedure of manufacturing a light transmitting yttria sintered body according to another exemplary embodiment of the present invention.

FIG. 8 is a photograph obtained by capturing images of external appearances of specimens manufactured according to the exemplary embodiment of the present invention.

FIG. 9 is a view for schematically explaining a cause of occurrence of a crack.

FIG. 10 is a graph obtained by measuring in-line transmittance in respect to a specimen according to the exemplary embodiment of the present invention.

### BEST MODE

Hereinafter, the present invention will be described in detail by describing an exemplary embodiment of the present invention.

A light transmitting yttria sintered body is manufactured by mixing and sintering yttria and sintering additives with high purity. In this case, divalent, trivalent or tetravalent metal compounds may be used as the sintering additives. For example, calcium, lanthanum, zirconium, or a precursor thereof is used. In particular, trivalent or tetravalent metal compounds may be used as the sintering additives in terms of compaction.

It is known that a compacted sintered body may be obtained by an appropriate sintering method, for example, hot-press sintering (hot press) or isotropic press sintering (hot isostatic press) in a state in which a ratio of a metal element, which constitutes the sintering additive for the light transmitting yttria sintered body, is 0.1 to 5.0 at %.

In the present invention, the yttria sintered body may be a composite body of which the composition includes only yttria or both yttria and a sintering additive. In the present invention, the metal element of 5.0 at % or less may be contained in the sintering additive. Oxides of Zr, La, Ca, or the like or a precursor thereof may be used as the sintering additive.

FIG. 1 is a view schematically illustrating an example of press-molding an yttria molded body according to an exemplary embodiment of the present invention.

Referring to FIG. 1, a hot-press sintering apparatus includes a pressing means 30 which presses a molded body 10 in a uniaxial direction, and a mold (not illustrated). In addition, the hot-press sintering apparatus includes a resistive heater (not illustrated) which is disposed at the periphery of the molded body and heats the molded body. Because the hot-press sintering apparatus, which includes the mold, the heater, and the like as described above, may be easily designed by those skilled in the art, a detailed description thereof will be omitted.

In the hot-press sintering apparatus, components such as the pressing means 30, the resistive heater, the mold, and the like may particularly be made of graphite. In addition, a vacuum ambience is generally maintained in the sintering apparatus during the hot-press sintering. To this end, the sintering apparatus may be provided with a vacuum pump or the like.

As illustrated in FIG. 1A, spacers 20 are provided between the molded body 10 and the pressing means 30. In the present exemplary embodiment, the spacers 20 are illustrated as being provided on both pressing surfaces of the molded body, but the spacer 20 may be provided only on one of the pressing surfaces in an axial direction. In addition, the spacer 20 may be disposed to cover the entire pressing surface, but the spacer 20 may also be disposed to cover only a part of the pressing surface.

The spacer 20 is made of metal which is unreactive to the yttria and the sintering additive at a sintering temperature during the hot-press sintering of the yttria molded body. The metal may be configured as heat-resistant metal having a melting point appropriately higher than the sintering temperature in consideration of a temperature of the hot-press sintering. For example, the spacer 20 may be at least one type of metal or an alloy of the metal selected from a group consisting of Ta, Mo, W, and Pt.

In the present invention, the spacer 20 may be implemented in the form of a plate having a predetermined thickness or a thin foil.

FIG. 1B is a view schematically illustrating a method of pressing the molded body according to another exemplary embodiment of the present invention.

As illustrated, the spacer 20 surrounds an outer circumferential surface of the molded body 10. As described above, the spacer 20 may be easily implemented in the form of a metal foil.

As illustrated in FIGS. 1A and 1B, the spacer 20 is implemented by plastically deformable metal, and as a result, a change in shape may depend on the deformation in the molded body (sintered body) during the uniaxial press sintering.

In the present invention, the heat-resistant metal is unreactive to the yttria sintered body and may be easily separated from the sintered body after the press sintering, and no undesired reaction product is produced at the periphery of a surface of the sintered body.

First, in the present exemplary embodiment, the heat-resistant metal prevents the pressing means 30 from coming into direct contact with the yttria.

The spacer may prevent the molded body and the mold from coming into direct contact with each other in the case in which the spacer covers the entire outer circumferential surface of the molded body as illustrated in FIG. 1B. In addition, the spacer 20 may be sealed to substantially block the ambience in the sintering apparatus. Therefore, it is possible to inhibit a reaction between carbon (gas) and the molded body under an ambient environment in the sintering apparatus, for example, under equilibrium vapor pressure. In the present invention, the metal spacer may be plastically deformable depending on an outer circumferential shape of the molded body, and may block the molded body (sintered body) in a high-pressure pressing environment from a peripheral gas ambience.

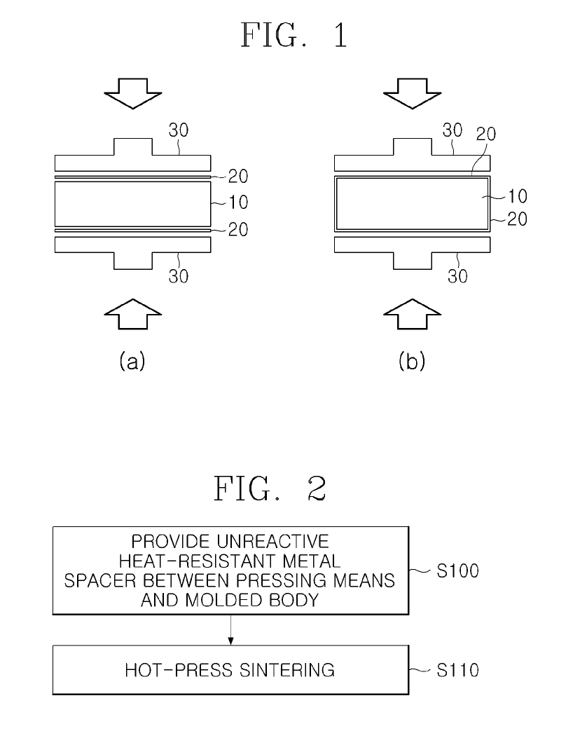

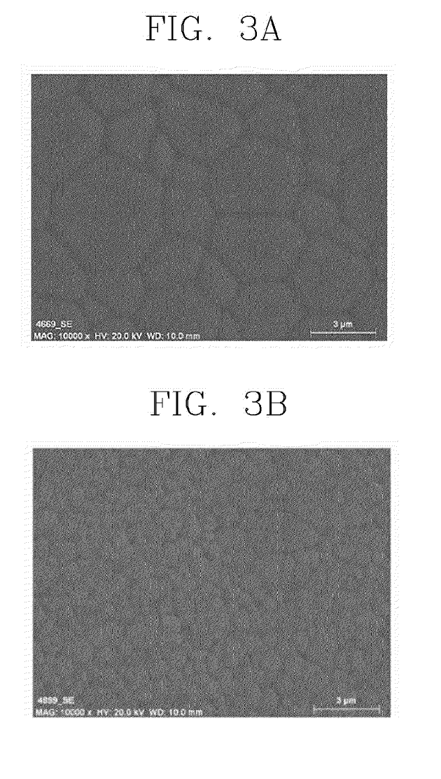

FIG. 2 is a view schematically illustrating a procedure of a process of manufacturing the light transmitting yttria according to the exemplary embodiment of the present invention.

Referring to FIG. 2, an unreactive heat-resistant metal spacer is provided on a pressing surface between a molded body made of a starting material for manufacturing light transmitting yttria and a pressing means of a hot-press sintering apparatus (S100). As described above, a specimen including the heat-resistant metal spacer is pressed by the pressing means and subjected to hot-press sintering (S110).

### MODE FOR INVENTION

Hereinafter, an example of manufacturing the light transmitting yttria sintered body described with reference to FIG. 2 will be described.

### EXAMPLE 1

Y₂O₃ powder having purity of 99.9% and an average particle diameter of about 1 μm was calcined in the air at 800° C. for 4 hours, and ZrO(CH₃COO)₂, which is a precursor of ZrO₂, a tetravalent metal oxide, was used as a sintering additive. A Zr content was 0.1 to 5.0 at % of a total amount of metal elements.

A starting material was mixed by a wet process. Ball milling mixing was performed for 24 hours by using a PE container, ZrO₂ balls, and absolute alcohol. After the mixing, the resulting product was dried in a rotary evaporator and then sifted by using a #100 sieve.

The sifted powder was molded by uniaxial pressing (hand press 5 MPa) by using a metal mold having a diameter of 15 mm and then hydrostatic-molded by pressure of 20 MPa. A diameter of a final molded body was 14.2 mm.

A specimen was inserted into an HP mold having a diameter of 15 mm in a state in which an outer circumferential surface of the molded body was surrounded by using a Ta foil having a thickness of 25 μm. As described above, the Ta foil isolates the specimen from the graphite mold, thereby inhibiting carbon contamination. In addition, the Ta foil serves to inhibit the occurrence of oxygen vacancy under an ambience of reduction of vacuum and carbon by isolating the molded body in the high-temperature pressing environment.

A two-step pressing process, in which pressing pressure is 10 MPa at 1,200° C. or lower and 20 MPa at the sintering temperature, was applied in a state in which a temperature raising speed was 5 to 10° C./min, the sintering temperature was 1,500 to 1,700 ° C., holding time was 2 to 6 hours, and a cooling speed was 10° C./min by using a typical hot-press sintering apparatus including a graphite heating element and a graphite thermal insulator. For comparison with the present exemplary embodiment, a specimen was prepared by performing a vacuum sintering process (temperature of 1,800° C. and holding time of 3 hours), an annealing process (temperature of 1,400° C. and holding time of 2 hours in the air), and an HIP process (temperature of 1,450° C., holding time of 5 hours, and Ar of 180 MPa). In addition, a specimen was also prepared by sequentially performing the hot-press sintering under the same condition as the present exemplary embodiment, and an HIP process (temperature of 1,450° C., holding time of 5 hours, Ar of 180 MPa).

The manufactured sintered bodies were observed by a scanning electron microscope (JSM-6700F, JEOL, Tokyo, Japan) and light transmittance was measured by a UV-VIS-NIR spectrophotometer (Cary 5000, Varian, Palo Alto, Calif., USA). The light transmittance was measured based on a specimen thickness of 2.0 mm. The manufactured specimens were analyzed by an FT-IR spectrometer (Nicolet iS10, Thermo Fisher Scientific Inc., Madison, Wis., USA), and a RAMAN spectrometer (LabRAM HR, Horiba Jobin Yvon, Longjumeau, France).

In addition, electrical specific resistance (bulk resistance) of the specimens was measured by an impedance meter (Novocontrol Alpha-Analyzer, Novocontrol Technologies GmbH, Montabaur, Germany) (Electrode: Ag paste, Specimen Loading: THMS600 hotstage, Linkam, UK). The specific resistance was measured at a temperature of 500° C.

FIG. 3A is an electron micrograph indicating a microstructure of the specimen to which the vacuum sintering, the annealing, and the HIP process are applied, and FIG. 3B is an electron micrograph obtained by capturing an image of a microstructure of the specimen sintered by hot-press sintering by applying the Ta foil. Hardness of the respective specimens was about 7 GPa and 8 GPa, and strength was not measured, but it is expected that the HP sintered specimen having a small particle size has high strength. The reason is that because the HP sintering may achieve compaction even at a temperature lower than a temperature of the vacuum sintering, the particles are inhibited from growing, and as a result, mechanical physical properties are relatively excellent.

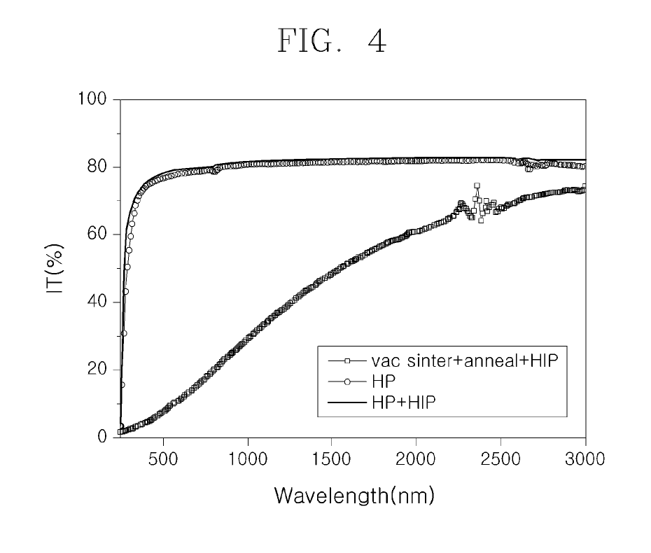

FIG. 4 illustrates data obtained by measuring and comparing in-line transmittance of the specimen (vac sinter+anneal+HIP) to which the vacuum sintering, the annealing, and the HIP process are applied, in-line transmittance of the HP sintered specimen (HP) to which the Ta foil is applied, and in-line transmittance of the specimen (HP+HIP) which is subjected to the HIP process after the HP sintering.

Even though the vacuum sintered specimen (vac sinter+anneal+HIP) was subjected to the subsequent HIP process, fine pores, which remain after the vacuum sintering, were not completely removed. Therefore, the specimen has low transmittance particularly in a visible light region. In contrast, the HP specimen has high transmittance approximate to theoretical transmittance not only in a region of the infrared wave which is a long wave but also in a region of the visible light which is a short wave, and the sintering has been achieved close to net density without pores.

Meanwhile, the HP+HIP specimen has transmittance similar to the transmittance of the specimen before the HIP process, and it can thus be seen that most of the fine pores have already been eliminated in the HP sintering step.

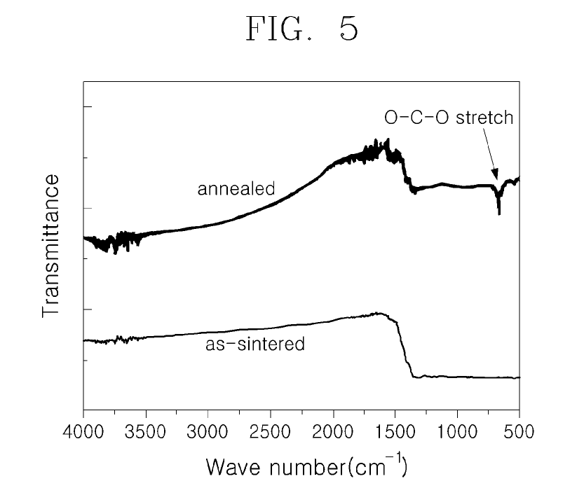

FIG. 5 illustrates an IR transmission aspect before and after annealing the vacuum sintered specimen, and a peak, which corresponds to O—C—O stretch and was not found in the (as-sintered) specimen before the annealing, was detected in the specimen after the annealing. That is, it is estimated that carbon contamination is present in an amorphous form in the (as-sintered) specimen before the annealing, and the amorphous carbon of the contamination is gasified in the form of CO₂ by the annealing in the air. The specimen according to the present exemplary embodiment, which is made by surrounding the specimen with the Ta foil and performing the HP sintering, immediately has high transmittance without annealing, and as a result, it can be seen that carbon contamination is significantly inhibited as described above.

The method of manufacturing the yttria sintered body according to the exemplary embodiment of the present invention enables the single hot-press sintering process, which was not enabled in the related art, to be applied to manufacture the light transmitting yttria. With the introduction of the aforementioned distinctive process, the light transmitting yttria sintered body according to the exemplary embodiment of the present invention has physical properties different from those of the light transmitting yttria sintered body in the related art.

First, the process of manufacturing the sintered body according to the exemplary embodiment of the present invention is clearly distinguished, in terms of whether the annealing process is involved, from the process in the related art. Therefore, it is expected that there is a clear difference in terms of concentration of oxygen vacancy of the final specimens.

That is, in the related art, the annealing process is applied, in the air, to yttria, that is, Y₂O₃₋ₓ (x>0) in a state in which oxygen is deficient after vacuum sintering, and as a result, it is expected that oxygen vacancy is filled and a material having a composition approximate to stoichiometry is manufactured. In contrast, according to the one-step HP sintering process according to the exemplary embodiment of the present invention, it is expected that because the annealing is not involved, a material, which has a composition deviating from stoichiometry, is manufactured due to relatively high oxygen vacancy concentration.

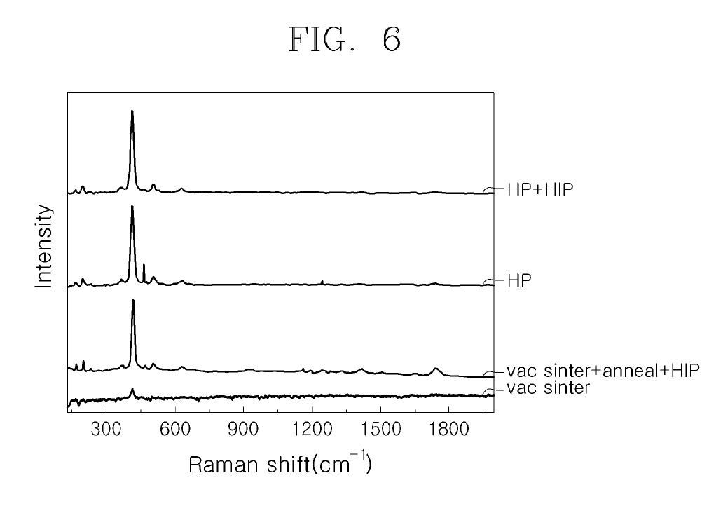

FIG. 6 is a graph illustrated for comparing Raman patterns of specimens manufactured by various sintering processes.

First, no peak other than a weak peak corresponding to Y—O vibration is detected due to oxygen vacancy in the specimen (vac sinter) manufactured by the vacuum sintering, but in the specimen (vac sinter+anneal+HIP) which is made by annealing the specimen and performing the HIP process, the oxygen vacancy is filled, such that peaks corresponding to all types of combinations are detected.

Meanwhile, since the HP specimen has a Raman pattern having an aspect corresponding to an intermediate level between the specimen (vac sinter specimen) and the specimen (vac sinter+anneal+HIP), it is estimated that oxygen vacancy concentration may be at an intermediate level between the two specimens. It is interpreted that the reason is that the sintering temperature of the HP specimen is lower by about 100 to 200° C. than the temperature of the vacuum sintering, and the specimen is isolated by the Ta foil from the carbon ambience, such that reduction (oxygen is withdrawn, which causes deviation from stoichiometry) is relatively less performed.

The concentration of the oxygen vacancy present in the sintered bodies may be relatively compared by measuring specific electrical resistance.

The following Table 1 shows results of measuring specific resistance of the specimens manufactured by the respective processes.

TABLE 1

| Specimen | Specific Electrical Resistance (@500° C.) |
|---|---|
| vac sinter + anneal + HIP | 1.07 * 10¹² Ω · cm |
| HP | 1.06 * 10⁹ Ω · cm |
| HP + HIP | 3.60 * 10¹⁰ Ω · cm |

As a result of measuring the specific resistance, the specific resistance of the existing vacuum sintered specimen (vac sinter+anneal+HIP), which is larger than the specific resistance of the HP specimen by about 10³ orders, is measured, and as a result, it can be seen that the HP specimen manufactured according to the exemplary embodiment of the present invention has relatively high concentration of oxygen vacancy that causes electrical conductivity. Meanwhile, it can be seen that the specimen (HP+HIP) also has specific electrical resistance equal to or higher than about 30 times the specific electrical resistance of the HP specimen.

As described above, a numerical value of specific electrical resistance, which represents concentration of oxygen vacancy, may be a criterion for determining whether to apply the annealing process to a transparent yttria component.

As described above, the light transmitting yttria manufactured according to the exemplary embodiment of the present invention has light transmitting properties equal to those of the light transmitting yttria sintered body in the related art. In contrast, the method of manufacturing light transmitting yttria according to the exemplary embodiment of the present invention does not require the annealing process and the HIP process, thereby significantly reducing the number of process facilities and process costs. The features of the process of the present invention affect physical properties of finished components such as concentration of oxygen vacancy or numerical values of specific resistance caused by the concentration of oxygen vacancy. That is, the light transmitting yttria according to the exemplary embodiment of the present invention has much lower specific electrical resistance than the light transmitting yttria in the related art. The light transmitting yttria sintered component according to the present invention has a specific electrical resistance value less than 10¹⁰ Ω·cm, or 1*10⁹ to 5*10⁹ Ω·cm in accordance with a sintering condition and a sintering additive content.

As described above, the present invention may manufacture polycrystalline transparent yttria having transmittance approximate to theoretical transmittance through the one-step process that applies the hot-press sintering after surrounding the molded body specimen with the unreactive heat-resistant metal foil. In addition, the present invention shows different ion conduction properties because the process costs are reduced and high concentration of oxygen vacancy is achieved in comparison with the existing process that performs the annealing.

Hereinafter, a method of manufacturing a light transmitting yttria sintered body according to another exemplary embodiment of the present invention will be described.

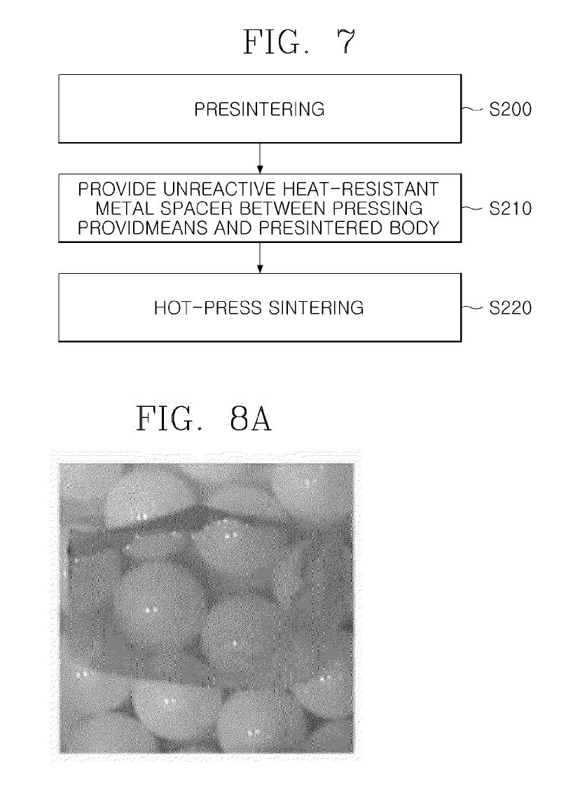

FIG. 7 is a procedure diagram schematically illustrating a procedure of manufacturing a light transmitting yttria sintered body according to another exemplary embodiment of the present invention.

Referring to FIG. 2, a molded body made of raw material powder for manufacturing yttria is presintered as described above (S200). Subsequently, an unreactive heat-resistant metal spacer is provided on a pressing surface between the presintered body and a pressing means of a hot-press sintering apparatus (S210). As described above, a specimen including the heat-resistant metal spacer is pressed by the pressing means and subjected to hot-press sintering (S110). Of course, as described above, in the present invention, the metal spacer may be formed to surround the presintered body.

Hereinafter, the exemplary embodiment of the present invention including the presintering will be described.

### EXAMPLE 2

Y₂O₃ powder having purity of 99.9% and an average particle diameter of about 1 μm was used, and ZrO(CH₃COO)₂, which is a precursor of ZrO₂, a tetravalent metal oxide, was used as a sintering additive. A Zr content was 1 at % of a total amount of metal elements.

A starting material was mixed by a wet process. Ball milling mixing was performed for 24 hours by using a PE container, ZrO₂ balls, and absolute alcohol. After the mixing, the resulting product was dried in a rotary evaporator, sifted by using a #150 sieve, and then calcined in the air at 800° C. for 4 hours.

The sifted powder was molded by uniaxial pressing (hand press 5 MPa) by using a quadrangular mold having a width of 15 mm and a length of 15 mm and then hydrostatic-molded by pressure of 20 MPa.

The molded body was presintered at 1,250 to 1,450° C. for 2 hours. A specimen, which was not subjected to the presintering, was also manufactured for comparison.

Subsequently, similar to Example 1, the hot-press sintering was performed at a temperature of 1,600° C. for 3 hours by using the HP mold in a state in which an outer circumferential surface of the presintered body is surrounded by the Ta foil. The other sintering conditions of the hot-press sintering were equal to those in Example 1.

Subsequently, the specimen sintered by the hot-press sintering was subjected to the HIP process at 1,450° C. for 5 hours with pressure of 180 MPa in an Ar gas ambience.

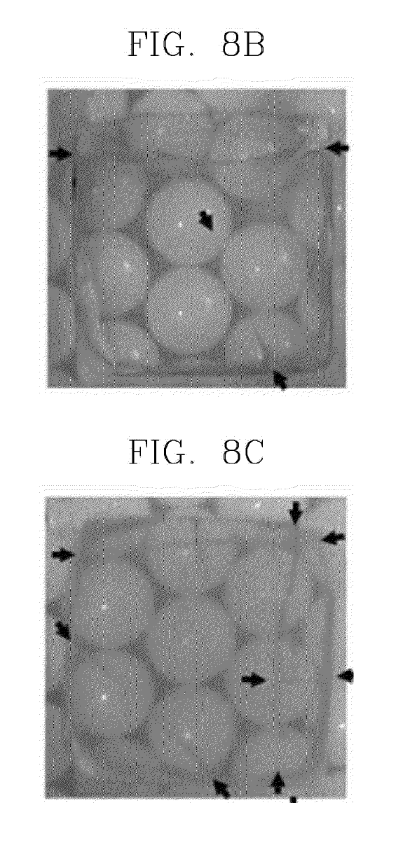

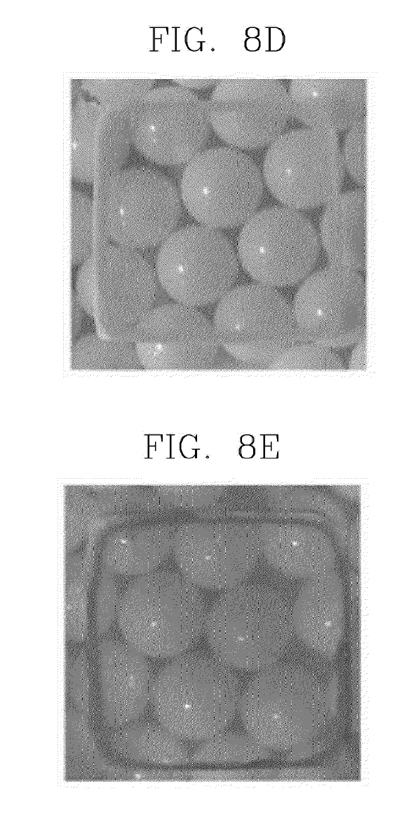

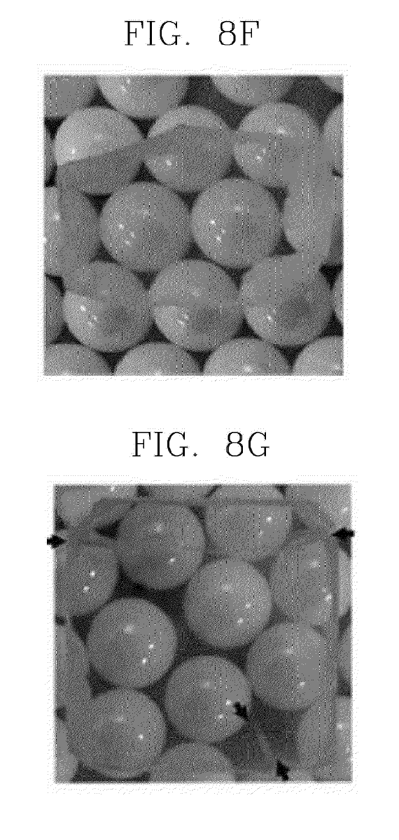

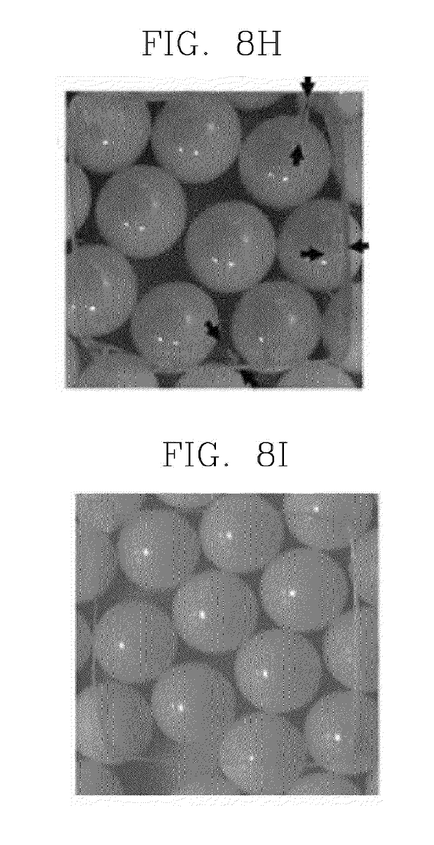

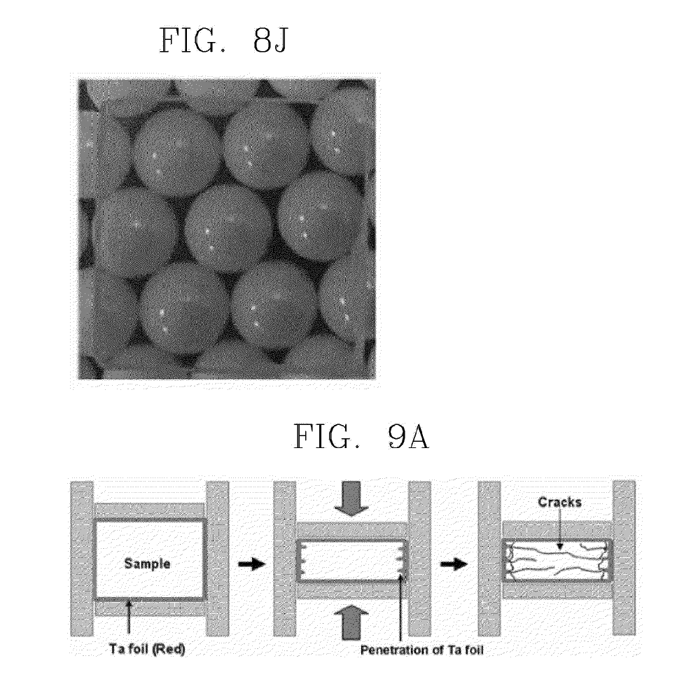

FIGS. 8A to 8E are photographs obtained by capturing images of external appearances of specimens presintered at 1,250° C., 1,300° C., 1,350° C., 1,400° C., and 1,450° C., respectively.

It can be seen that cracks occurred in the presintered specimens in FIGS. 8A to 8C, but no crack occurred in the specimens in FIGS. 8D and 8E. In the case of the specimen in FIG. 8A, the crack grew toward the entire specimen and the specimen was broken. In the photographs in FIG. 8, start points and end points of the cracks are indicated by arrows.

Meanwhile, photographs, which are obtained by capturing images of the presintered specimens (a) to (e) subjected to the HIP process, are illustrated in FIGS. 8F to 8J.

Referring to FIGS. 8F to 8J, it can be seen that the respective specimens have transparency in comparison with the specimens before the HIP process is performed. Furthermore, it can be seen that the cracks illustrated in FIGS. 7B and 7C are not observed after the HIP process. That is, it can be seen that the defect such as the crack caused by the hot-press sintering is repaired by the HIP process.

It is estimated that the occurrence of the cracks related to FIG. 8 results from the defect caused by deformation in the Ta foil used as the spacer. Although photographs are not separately provided, cracks also occurred in the light transmitting yttria specimens manufactured in Example 1, that is, the specimens which were not subjected to the presintering.

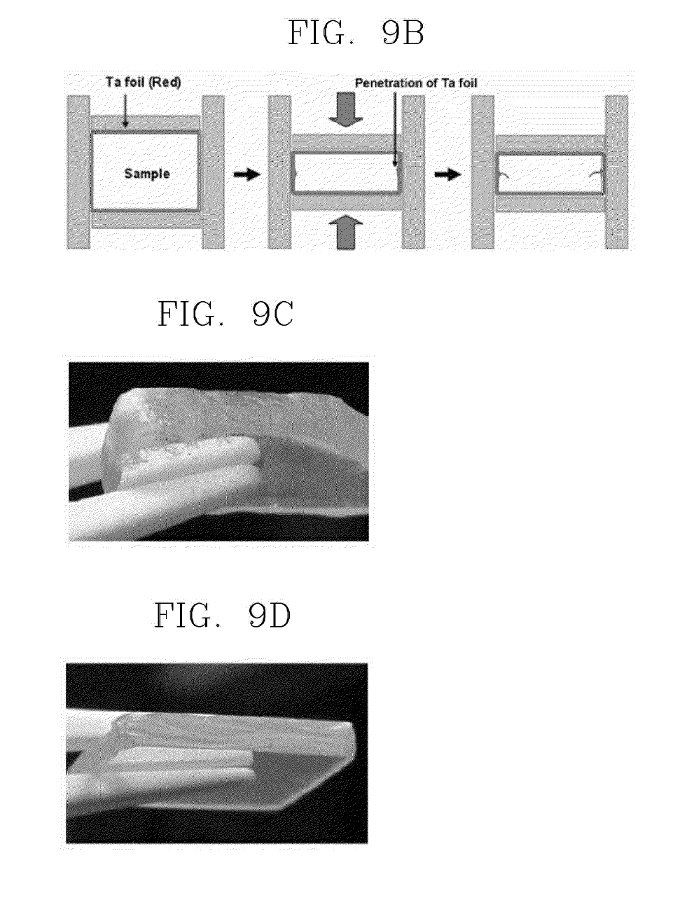

FIG. 9 is a view for schematically explaining a cause of occurrence of a crack in the present exemplary embodiment.

First, as illustrated in a series of drawings in FIG. 9A, the Ta foil is deformed at a lateral side of the specimen when the specimen is shrunk by compressive force applied to the pressing surface of the specimen during the hot-press sintering. The deformed Ta foil causes occurrence of cracks in a relatively weak molded body or presintered body, and the specimen may be broken as the formed crack grows.

However, in a case in which a temperature of the presintered body is high as illustrated in FIG. 9B, the presintered body has relatively high density and high strength, such that the deformation in the foil into the presintered body may be inhibited. For example, in the case of the specimen in FIG. 7B which is presintered at 1,300° C. and 1,350° C., the formed crack does not grow over the entire specimen.

The following Table 2 shows a result of measuring relative density of the specimens presintered at the respective presintering temperatures.

TABLE 2

| Presintering Temperature (° C.) | Relative Density (%) |
|---|---|
| Molded Body | ~44 |
| 1,250° C. | 45.9 |
| 1,300° C. | 46.7 |
| 1,350° C. | 47.8 |
| 1,400° C. | 49.5 |

In Table 2, the relative density is a percentage obtained by dividing density (mass/volume) of the presintered body by theoretical density of yttria. Therefore, particularly, the yttria presintered body according to the exemplary embodiment of the present invention may have relative density of 46% or more, more particularly, relative density of 47% or more.

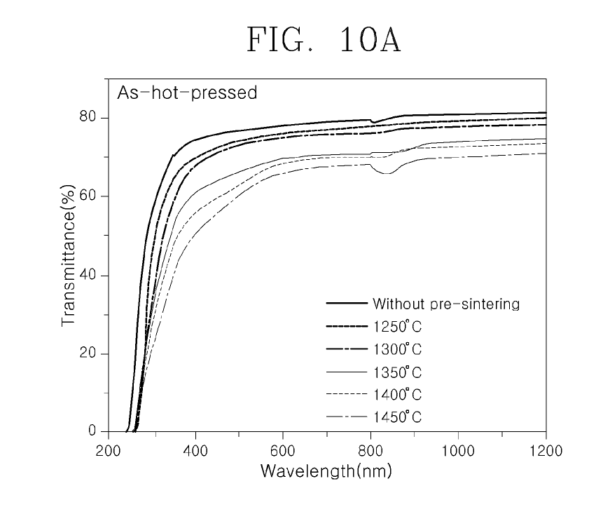

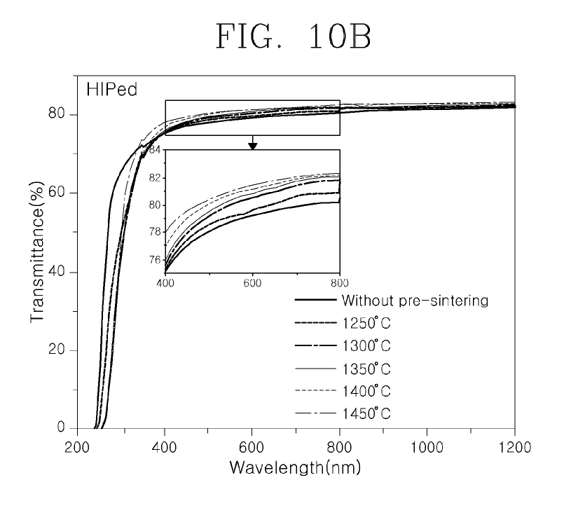

FIG. 10 is a graph obtained by measuring in-line transmittance in respect to a specimen according to the exemplary embodiment of the present invention.

FIG. 10A is a graph illustrating transmittance of a specimen which is subjected to hot-press sintering after presintering. Referring to FIG. 10A, it can be seen that the specimen, which is not subjected to the presintering, has higher transmittance than the specimen which is subjected to the presintering, and transmittance of the specimen, which is subjected to the presintering, is decreased as the presintering temperature is increased.

Meanwhile, as illustrated in FIG. 10B, in the case in which the HIP is performed, the specimen, which is not subjected to the presintering, has the lowest transmittance over a visible ray region and a near infrared ray region. In contrast, it can be seen that transmittance of the specimen, which is subjected to the presintering, is increased as the presintering temperature is increased. The specimen, which is subjected to the presintering, has transmittance of 80% or more at 1,100 nm, and the specimen, which is presintered at 1,450° C. and then subjected to the HIP process, has transmittance of 78.0% at 400 nm and 83.2% at 1,100 nm. In addition, the specimen, which is not subjected to the presintering, has a property of blocking a shorter wavelength, and has high transmittance in a UV region (250 to 380 nm).

### INDUSTRIAL APPLICABILITY

The present invention may be applied to an apparatus for manufacturing semiconductors and optical components such as a transparent window, a transparent dome, and a laser host material.

1. A method of manufacturing light transmitting yttria by performing hot-press sintering on a molded body made of raw material powder including yttria by using a hot-press sintering apparatus,
wherein the hot-press sintering is performed in a state in which a spacer is interposed between the molded body and a pressing surface of the molded body, and
the spacer is made of heat-resistant metal which is substantially unreactive to the molded body at a sintering temperature.

2. The method of claim 1, wherein the heat-resistant metal includes at least one type of metal selected from a group consisting of Ta, Mo, W, and Pt.

3. The method of claim 1, wherein the sintering temperature is 1,500 to 1,700° C.

4. The method of claim 1, wherein the spacer has a plate shape.

5. The method of claim 1, wherein the spacer has a foil shape.

6. The method of claim 1, wherein the spacer surrounds an outer circumference of the molded body.

7. The method of claim 1, wherein the spacer is separable from the light transmitting yttria.

8. The method of claim 1, wherein the hot-press sintering apparatus includes a graphite heater.

9. The method of claim 1, wherein the raw material powder further includes a sintering additive, and the sintering additive is a tetravalent metal compound.

10. A light transmitting yttria sintered component which includes a tetravalent metal element of 0.1 to 5 at % as a sintering additive, wherein specific electrical resistance is 1.0 to 5.0×10⁹ Ωcm.

11. The light transmitting yttria sintered component of claim 10, wherein the metal element is Zr.

12. The light transmitting yttria sintered component of claim 10, wherein in-line transmittance of the light transmitting yttria sintered component is 80% or more in a wavelength of 1,100 nm.

13. A method of manufacturing light transmitting yttria from a molded body made of raw material powder including yttria, the method comprising:
presintering the molded body; and
sintering the molded body by hot-press sintering by interposing a spacer between the molded body and a pressing surface of the molded body,
wherein the spacer surrounds an outer circumference of the molded body and is made of heat-resistant metal which is substantially unreactive to the molded body at a sintering temperature.

14. The method of claim 13, further comprising:
performing an HIP process after the hot-press sintering.

15. The method of claim 13, wherein a presintering temperature is 1,250 to 1,450° C., and a hot-press sintering temperature is 1,500 to 1,700° C.

16. The method of claim 15, wherein the presintering temperature is 1,400° C. or higher.

17. A light transmitting yttria sintered component which includes a tetravalent metal element of 0.1 to 5 at % as a sintering additive, the light transmitting yttria sintered component comprising:
a light transmitting yttria body which has specific electrical resistance of 1.0 to 5.0×10⁹ Ωcm; and
an unreactive heat-resistant metal spacer which surrounds the light transmitting yttria body.

18. The light transmitting yttria sintered component of claim 17, wherein the heat-resistant metal spacer has a foil shape.
